(19) United States
(12) Patent Application Publication
(10) Pub. No.: US 2006/0152945 A1
(43) Pub. Date: Jul. 13, 2006

(54) Universal lamp

(75) Inventors: Klaus Lantzsch, Eisenach (DE); Stefan Graeser, Neudietendorf (DE)

Correspondence Address: SUGHRUE MION, PLLC, 2100 PENNSYLVANIA AVENUE, N.W., SUITE 800, WASHINGTON, DC, 20037, US

(73) Assignee: FER FAHRZEUGELEKTRIK GMBH

(21) Appl. No.: 10/854,745

(22) Filed: May 27, 2004

(30) Foreign Application Priority Data
May 30, 2003 (DE) 203 08 466.7

(51) Int. Cl. H01R 33/00

(52) U.S. Cl. 362/640

(57) ABSTRACT

A universal lamp includes: a lamp module (1′) with a light source, a stationary holder (15) to which the lamp module can be easily releasably connected, and a power supply device which includes two electrical contacts (9′) which are provided on the holder and which are conductingly connected to a power supply and two electrical contacts (7′) which are provided on the lamp module and which are conductingly connected to the light source and, when the lamp module is connected to the holder, are conductingly connected to the electrical contacts thereof, wherein at least one electrical contact on the holder and at least one electrical contact on the lamp module are in the form of a magnet arrangement for holding the lamp module fast to the holder. An additional module (17) serves for achieving universal usability, which additional module includes a storage device for electrical energy and two electrical contacts and can be connected in easily releasable fashion to the lamp module so that the storage device for electrical energy can supply the light source with electrical energy.

The invention concerns a universal lamp, in particular for use in a vehicle, of the kind set forth in the classifying portion of claim 1.

Interior lamps in particular for motor vehicles are known, the brightness of which can be altered for example by means of a dimmer or a rheostat. Other known lamps have an optical arrangement which is disposed in front of the light source and which is mechanically displaceable to alter the spread angle of the light cone emitted by the lamp. In all those cases a comparatively high level of technical complication and expenditure is required to be able to adapt the light conditions to the respective instantaneous needs.

In comparison therewith the object of the invention is to develop a universal lamp of the kind set forth in the opening part of this specification, such that, with a very low level of technical complication and expenditure, it can be adapted to differing light requirements and can be varied and used in many different ways.

To attain that object the invention provides the features set forth in claim 1.

In accordance with the invention a universal lamp comprises substantially at least three main components, namely at least one movable lamp module which defines the lamp properties of the universal lamp, at least one stationary holder for the movable lamp module and at least one additional module which contains an electrical energy storage device and to which the lamp module can be connected to form a portable lamp when it has been removed from the stationary holder. The fact that those main components are each connected together in easily releasable manner means that, for a holder, it is possible to provide a plurality of lamp modules whose mechanical structure is admittedly identical but which differ from each other for example in terms of brightness and/or color and/or spread angle of the light beam that they emit. For a variation in the instantaneous illumination situation, it is then only necessary to replace one lamp module by another.

The easily releasable connection between the stationary holder and the lamp module on the one hand and the additional module and the lamp module on the other hand is afforded by means of contacts which have a dual function, namely on the one hand they serve to make an electrically conducting connection between a current source connected to the stationary holder or the electrical energy storage device provided in the additional module respectively, and the light source or sources in the lamp module, and on the other hand they apply magnetic holding forces which provide for a stable connection of the lamp module to the stationary holder and the additional module respectively. In addition those magnetic forces which act directly at the contacts themselves also ensure good electrical contact when the contacts involve surface contacts which bear flat against each other, as is preferably the case.

A particular advantage of the use of an additional module is that the lamp module can be of a particularly small and aesthetically attractive configuration as it itself does not have to accommodate any energy storage device.

Admittedly it is possible in principle for only one of the two pairs of electrical contacts, of which one contact is on the holder and the other on the lamp module, to be of a magnetic nature in order to achieve the required holding forces, but preferably both pairs of electrical contacts are also magnetic at the same time.

In order to also ensure that the lamp can be used at any time as a portable lamp, there is preferably provided a holder which includes a receiving means for the additional module with electrical contacts, by way of which the electrical energy storage device of the additional module can be connected in the fitted condition to an electrical energy source from which it can be charged.

In order to be able to avoid specific contact protection from touching the contacts provided on the holder, the power supply arrangement used is preferably a low-voltage current source. Light emitting diodes are particularly preferred as the light source.

These and further advantageous configurations of the interior lamp according to the invention are set forth in the appendant claims.

The invention is described hereinafter by means of embodiments with reference to the drawing in which:

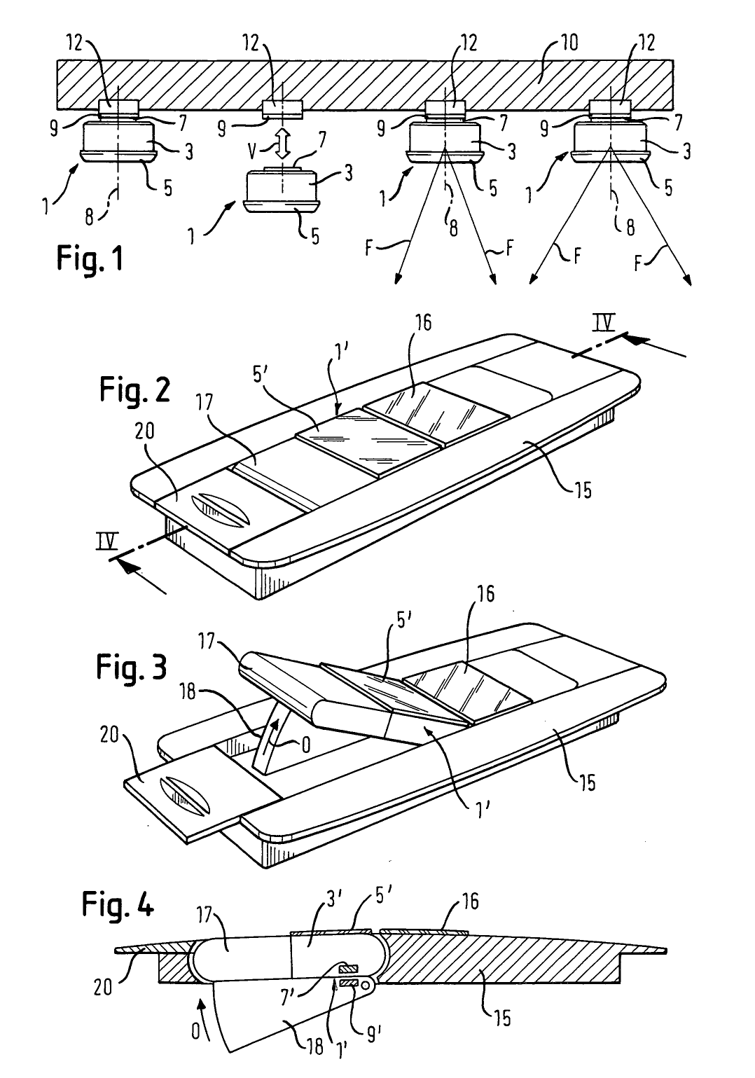

FIG. 1 is a highly diagrammatic, partly sectional side view of an interior lamp with a plurality of lamp modules according to the invention,

FIG. 2 is a greatly simplified perspective view of an interior lamp suitable in particular for motor vehicles, with a stationary light source and a combination according to the invention of a lamp module and an additional module,

FIG. 3 shows the same perspective view of the interior lamp of FIG. 2, the combination according to the invention of the lamp module and the additional module being shown tilted in relation to its operational position of installation,

FIG. 4 shows a view in section through the structure of FIG. 2 taken along line IV-IV,

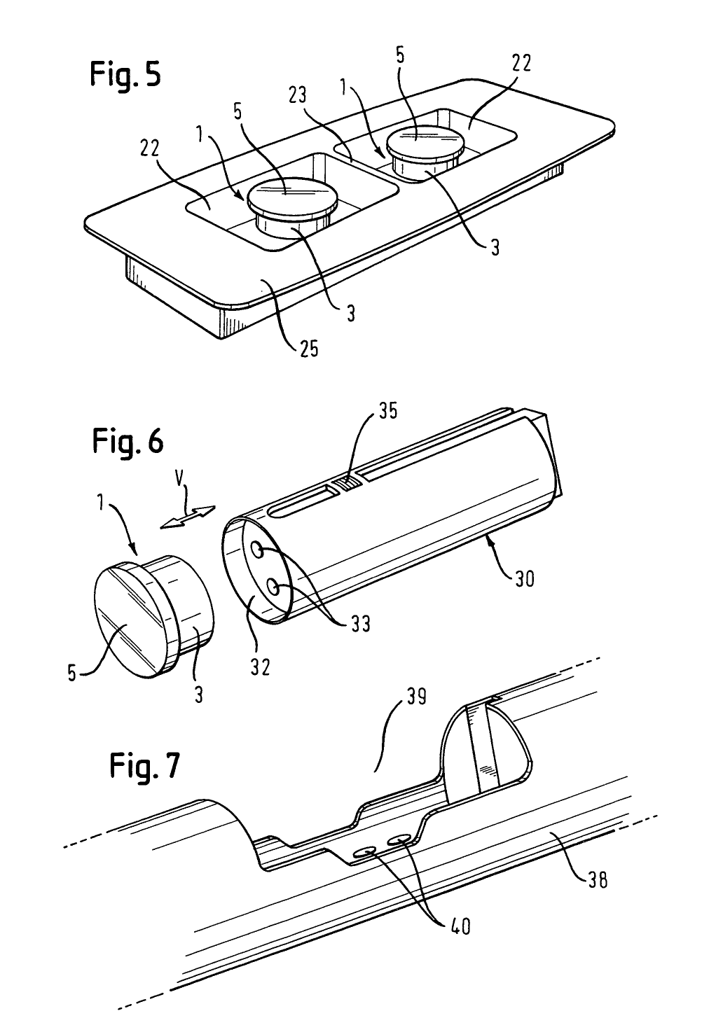

FIG. 5 shows a view similar to FIG. 2 of a further embodiment in which the interior lamp has two lamp modules according to the invention,

FIG. 6 shows a perspective view of one of the lamp modules of FIG. 5 with an additional module which contains a chargeable electrical energy storage device (accumulator), and

FIG. 7 shows a perspective view of a holder into which the additional module of FIG. 6 can be fitted in order to charge up the accumulator contained therein.

Referring to FIG. 1 shown therein are four lamp modules 1 according to the invention, each of which has an approximately circular-cylindrical housing 3 closed at its side which is disposed downwardly in FIG. 1, by a light transmission cover 5. Disposed in the interior of each housing 3 is a light source (not shown) whose downwardly directed light beam issues through the light transmission cover 5, as is shown diagrammatically by the arrows F in respect of the two light modules which are at the right in FIG. 1.

On the outside of its housing bottom which is upward in FIG. 1, each of the light modules 1 has two mutually insulated electrical contacts 7 of which however there is only ever one visible in FIG. 1. Those two contacts can be for example in the form of a circular surface which is concentric with respect to the main axis 8 of the housing and a circular ring which is in concentric relationship with the circular surface, in order to provide for complete radial symmetry of the lamp modules 1 with respect to the main axis 8.

Provided on a carrier 10 which can be for example a roof element in the interior of a motor vehicle are four docking stations or holders 12, each of which can be connected to one of the lamp modules 1 in easily releasable manner, as is indicated for the second lamp module from the left by the double-headed arrow V. Each of the holders 12 has two contacts 9 (only one is visible) which correspond in form and arrangement to the contacts 7 of the lamp modules 1.

It is essential in that respect that all contacts comprise an electrically conducting material and the contacts 7 of the lamp modules 1 are in electrically conducting relationship with the respective light source or sources which are disposed in the interior of the housing 3 and which are preferably formed by light emitting diodes (LEDs), in such a way that the contacts can serve for the current supply thereto.

The two contacts 9 at each of the holders 12 are electrically conductingly connected to a low-voltage current supply, in a situation involving use in a vehicle for example to a vehicle on-board system.

In addition at least one of the two contacts 9, at each of the holders 12, with the contact 7 associated therewith at each of the lamp modules 1, forms a magnet arrangement by virtue of the fact that one of them is in the form of a permanent magnet and the other is in the form of a permanent magnet of opposite polarity or in the form of a ferromagnetic element. The connection which can be easily released, between each of the lamp modules 1 and the associated holder 12, is thus made and held by the magnetic attraction forces which prevail between at least one contact 7 on the lamp module 1 and at least one contact 9 on the holder 12.

Preferably however both contacts on each of the holders 12 and both contacts on each of the lamp modules 1 are so designed that they contribute to magnetic attraction between the holder 12 and the lamp module so that each pair of contacts serves both for holding purposes and also at the same time to provide the electrical power supply. The magnetic field strengths on the one hand and the weight of each lamp module 1 on the other hand can be so selected, in particular when using one or more LEDs as the light source or sources, that no additional holding forces and/or locking arrangements are required even in the cases in which the entire lamp assembly is subjected to vibration, as can be the case for example when used in the interior of a vehicle, in particular a motor vehicle.

The differing spread angles of the light cones which are produced by the two lamp modules 1 arranged at the right in FIG. 1 are intended to indicate that the lamp modules 1 do not have to be identical in respect of their light properties. Besides differing radiation angles they may also contain light sources involving differing brightness and/or differing light color. Accordingly simple interchangeability of the lamp modules 1 means that an interior lighting arrangement can be of different configurations and can be adapted to changing requirements of the moment, without involving a high level of complication and expenditure.

Referring to FIGS. 2 through 4 shown therein is an interior lamp in which the holder includes a frame housing 15 which accommodates a stationary lamp of which only the light transmission cover 16 is visible, and a universal lamp according to the invention, of the lamp module 1′ of which only the light transmission cover 5′ is visible in FIG. 2, a light source, preferably an LED, being disposed behind the light transmission cover 5′.

The lamp module 1′ here is in the form of a shallow parallelepiped whose short end edge which is at the right in the Figures is rounded off. It is fitted jointly with an additional module 17 of approximately the same shape into the frame housing 15 serving as a holder for both modules 1′, 17, in such a way that the top sides of the two modules 1′, 17 are substantially aligned with that of the frame housing 15.

The two modules 1′, 17 are connected together both electrically and also magnetically by way of pairs of contacts (not shown) in such a way that they can be jointly handled or if desired can also be easily separated from each other.

At the side in opposite relationship to the light transmission cover 5′ the housing 3′ carries two contacts 7′ of which only one is to be seen in the sectional view in FIG. 4 and in opposite relationship to which there are two contacts 9 (also only one is visible) which, in the same manner as was described hereinbefore with reference to FIG. 1, are connected to an electrical energy source (not shown) and both serve for the electrical power supply to the light source or sources in the interior of the lamp module 1′ and also at the same time provide for magnetic attraction between the holder formed by the frame housing 15, and the lamp module 1′.

The additional module 17 contains a storage device for electrical energy, for example a battery or an accumulator, which, when the two modules 1′, 17 are jointly fitted into the frame housing 15, can be charged by way of the above-mentioned contacts (not shown) which form a connection between the additional module 17 and the lamp module 1′, and the contacts 7, 9 which make a connection between the lamp module 1′ and the above-mentioned electrical energy source, and, when the two modules 1′, 17 are removed from the frame housing 15, the battery or accumulator serves for the supply of power to the light sources in the lamp module 1′. In that way that lamp module 1′ can also be used in conjunction with the additional module 17 as a portable lamp which is actuable by a switch (not shown).

As in this embodiment the outsides of the modules 1′, 17 are in virtually flush alignment with the outside of the frame housing 15, the arrangement has a spring bar 18 to facilitate removal. When the locking assembly formed by a slider 20 of the frame housing 15 is displaced towards the left as shown in FIG. 3, the spring bar 18 urges the interconnected modules 1′, 17 upwardly in the direction of the arrow O so that they can be readily jointly gripped and removed from the frame housing 15.

In the embodiment shown in FIG. 5 fitted in a frame housing 25 which is similar to that shown in FIGS. 2 through 4 are two lamp modules 1 according to the invention which correspond to those shown in FIG. 1, that is to say they each have a circular-cylindrical housing 3 which is closed at its one end by a light transmission cover 5 while at its end which is the lower end in FIG. 5 it carries contacts (not visible) which again serve at the same time as electrical power supply contacts and magnetic holding contacts. Around each of the lamp modules 1 the frame housing 25 has a recess 22 which is separated from the other by a land 23 and each of which is so dimensioned that the lamp module 1 fitted therein can be easily gripped by hand and can be removed from the frame housing 25 against the holding force of the magnet contacts.

Referring to FIG. 6 shown therein are one of the lamp modules 1 from FIG. 5 and an additional module 30 which is substantially of the circular-cylindrical shape of the body of a portable flashlight. At the end which is towards the lamp module 1 the additional module 30 has a circular depression 32 whose inside diameter is only slightly larger than the outside diameter of the circular-cylindrical housing 3 of the lamp module 1 so that it can be fitted into the depression 32 in the direction indicated by the arrow V. Provided at the bottom of the depression 32 are two contacts 33 which, as has already been described on a number of occasions, both serve to form an electrical connection to corresponding contacts provided on the bottom surface of the cylindrical housing 3 and also for magnetically holding the lamp module 1. Provided in the interior of the additional module 30 is a storage device for electrical energy in the form of one or more batteries or one or more rechargeable accumulators so that the lamp module 1 can be supplied with electrical energy by the actuation of a switch 35. Besides its use with the stationary holder 25 therefore it can also serve in conjunction with the additional module 30 as a portable lamp.

With reference to FIG. 7, diagrammatically shown therein is a holder 38 which for example can be integrated into the armrest on the inside of a motor vehicle door and which has a receiving means 39 into which the additional module 30 can be fitted. Further magnet contacts 40 can be provided in the holder 38. The contacts 40 both provide for a shake-resistant but easily releasable connection between the additional module 30 and the holder 38, while by way of the contacts 40 it is also possible to make electrical contact with corresponding contacts (not shown) on the additional module 30 in order to be able to charge up an accumulator contained in the additional module 30.

As an alternative to the illustrated embodiment the contacts 33 can also be used for retaining the additional module 30 fixed in the holder 38 and for recharging the accumulator, in return for which the contacts 40 are then arranged at a suitable position other than that illustrated.

1.-13. (canceled)

14. A lamp including
at least one holder,
at least one lamp module comprising at least one light source and a light transmission cover and releasably connectable to the holder,
a power supply device which includes at least two electrical contacts on the holder and electrically conductingly connected to a power supply, and at least two electrical contacts on the lamp module and electrically conductingly connected to the light source,
the arrangement being such that when the lamp module is connected to the holder the contacts of the lamp module are electrically conductingly connected to the electrical contacts of the holder,
wherein at least one of the electrical contacts on the holder and at least one of the electrical contacts on the lamp module form a magnet arrangement for holding the lamp module fast on the holder, and
an additional module which includes an electrical energy storage device and at least two electrical contacts and to which the lamp module is releasably connectable such that the storage device when the lamp module is connected to the additional module can supply the at least one light source with electrical energy.

15. A lamp as set forth in claim 14
wherein two of the electrical contacts on the holder and two of the electrical contacts on the lamp module are adapted to form a magnet arrangement for holding the lamp module on the holder.

16. A lamp as set forth in claim 14
wherein the lamp module includes an electrical energy storage device which when the lamp module is connected to the holder is chargeable from the power supply and when the lamp module is separated from the holder is operable to supply the at least one light source with electrical energy.

17. A lamp as set forth in claim 14 including
a magnet arrangement producing magnetic attraction forces to hold the lamp module to the additional module, thereby to form the releasable connection between the additional module and the lamp module.

18. A lamp as set forth in claim 17
wherein at least one of the electrical contacts on the lamp module and at least one of the electrical contacts on the additional module are adapted to form the magnet arrangement for holding the lamp module fast to the additional module.

19. A lamp as set forth in claim 18
wherein two of the electrical contacts on the lamp module and two of the electrical contacts on the additional module are adapted to form the magnet arrangement for holding the lamp module fast to the additional module.

20. A lamp as set forth in claim 18
wherein both magnetic and also electrical contacts on the lamp module serve for selectively making the releasable connection of the lamp module both to the holder and also to the additional module.

21. A lamp as set forth in claim 14 including
a further holder to which the additional module is releasably connectable,
wherein the further holder has at least two electrical contacts which are electrically conductingly connected to the power supply and when the additional module is connected to the further holder are electrically conductingly connected to at least two electrical contacts on the additional module to charge up the electrical energy storage device in the additional module.

22. A lamp as set forth in claim 21 including
a further magnet arrangement producing magnetic attraction forces to releasably hold the additional module to the further holder.

23. A lamp as set forth in claim 22
wherein at least one of the electrical contacts on the further holder and at least one of the electrical contacts on the additional module are adapted to form the further magnet arrangement for holding the additional module to the further holder.

24. A lamp as set forth in claim 23
wherein two of the electrical contacts on the further holder and two of the electrical contacts on the additional module are adapted to form the further magnet arrangement for holding the additional module to the further holder.

25. A lamp as set forth in claim 24
wherein the two both magnetic and also electrical contacts on the additional module serve for the selective connection thereof to the further holder and to the lamp module.

26. A lamp as set forth in claim 14 for use on a vehicle,
wherein said power supply is derived from a vehicle on-board system.

27. A lamp as set forth in claim 14 in the form of a vehicle interior lamp.
